(19) United States
(12) Patent Application Publication
(10) Pub. No.: US 2018/0187725 A1
(43) Pub. Date: Jul. 5, 2018

(54) WEDGE CLUTCH WITH WEDGE PLATE SEGMENTS, CAGE AND WAVE SPRING AND METHOD THEREOF

(71) Applicant: Schaeffler Technologies AG & Co. KG, Herzogenaurach (DE)

(72) Inventors: Marion Jack Ince, Mount Holly, NC (US); Guihui Zhong, Charlotte, NC (US)

(73) Assignee: Schaeffler Technologies AG & Co. KG, Herzogenaurach (DE)

(21) Appl. No.: 15/396,850

(22) Filed: Jan. 3, 2017

(51) Int. Cl. F16D 13/16; F16D 13/66; F16D 13/70

(52) U.S. Cl. CPC F16D 13/16; F16D 13/70; F16D 13/66

(57) ABSTRACT

A wedge clutch, including: an axis of rotation; a hub; an outer ring located radially outward of the hub; a cage radially disposed between the hub and the outer ring; a plurality of circumferentially aligned wedge plate segments radially disposed between the hub and the outer ring; and a circumferentially continuous resilient element engaged with the cage and the plurality of circumferentially aligned wedge plate segments, and urging the plurality of circumferentially aligned wedge plate segments radially inward.

### TECHNICAL FIELD

The present invention relates generally to a wedge clutch, and, more specifically, to a wedge clutch having a plurality of circumferentially aligned wedge plate segments partially contained within a cage and including a circumferentially continuous resilient element arranged to urge the wedge plate segments into contact with a hub for the clutch.

### BACKGROUND

Known wedge plate clutches, for example for use with all-wheel drive applications, typically use one or more one-piece, scalloped, single-split wedge plates to connect and disconnect two shafts. A single-split wedge plate results in unequal locking pressure in a locked mode non-rotatably connecting the two shafts. As a result of the unequal locking pressure, the torque-bearing capacity and durability of the clutch are compromised. Further, when the hub of the clutch is mounted to a rotating shaft and the wedge plate is mounted on the outer tapered surface of the hub, in the free-wheel mode (the shafts connected to the clutch are to rotate with respect to each other), centrifugal forces from the rotation of the hub can force the wedge plate to move radially outward at high speed to engage the outer ring of the clutch, resulting in an unintentional shift to the locked mode.

To address the problem of unequal radial movement of the wedge plate, it is known to replace the one-piece wedge plate in a wedge clutch with a plurality of circumferentially aligned wedge plate segments. The wedge segments are arranged around a tapered hub and are positioned with a retaining ring, which also functions as a spring to enable the wedge segments radial movement. However, the retaining ring, like the one-piece wedge plates, has a single-split and therefore does not allow equal radial movement of the wedge segments. The single-split design also limits the ability of the retaining ring to prevent undesired radially outward displacement of the wedge plate segments (due to rotation of the hub) during the free-wheel mode.

### SUMMARY

According to aspects illustrated herein, there is provided a wedge clutch, including: an axis of rotation; a hub; an outer ring located radially outward of the hub; a cage radially disposed between the hub and the outer ring; a plurality of circumferentially aligned wedge plate segments radially disposed between the hub and the outer ring; and a circumferentially continuous resilient element engaged with the cage and the plurality of circumferentially aligned wedge plate segments, and urging the plurality of circumferentially aligned wedge plate segments radially inward.

According to aspects illustrated herein, there is provided a wedge clutch, including: an axis of rotation; a hub including a radially outermost surface sloping radially outward in a first axial direction; an outer ring located radially outward of the hub; a plurality of circumferentially aligned wedge plate segments radially disposed between the hub and the outer ring and in contact with the hub; a cage radially disposed between the hub and the outer ring and including a plurality of retention tabs, each retention tab, included in the plurality of retention tabs, overlapping a respective pair of circumferentially aligned wedge plate segments included in the plurality of circumferentially aligned wedge plate segments; and a resilient element engaged with the cage and the plurality of circumferentially aligned wedge plate segments, and urging the plurality of circumferentially aligned wedge plate segments radially inward. For a locked mode: the hub is axially displaceable in a second axial direction, opposite the first axial direction, to displace the plurality of circumferentially aligned wedge plate segments radially outward into contact with the outer ring; and the plurality of circumferentially aligned wedge plate segments are arranged to non-rotatably connect to the hub and the outer ring. For a free-wheel mode: the hub is axially displaceable in the first axial direction; the resilient element is arranged to displace the plurality of circumferentially aligned wedge plate segments radially inward; and the plurality of circumferentially aligned wedge plate segments is rotatable with respect to the outer ring.

According to aspects illustrated herein, there is provided a method of operating a wedge clutch including a hub, an outer ring, a circumferentially continuous resilient element, a plurality of wedge plate segments radially located between the hub and the outer ring, and a cage radially located between the hub and the outer ring, the method including: engaging, with the circumferentially continuous resilient element, the cage and the plurality of circumferentially aligned wedge plate segments; urging, with the circumferentially continuous resilient element, the plurality of circumferentially aligned wedge plate segments radially inward; contacting the hub with the plurality of circumferentially aligned wedge plate segments; for a locked mode, displacing the hub in a first axial direction, displacing, with the hub, the plurality of circumferentially aligned wedge plate segments radially outward into contact with the outer ring, and non-rotatably connecting the plurality of circumferentially aligned wedge plate segments with the hub and the outer ring; and for a free-wheel mode, displacing the hub in a second axial direction opposite the first axial direction, displacing, with the circumferentially continuous resilient element, the plurality of circumferentially aligned wedge plate segments radially inward, and rotating the plurality of circumferentially aligned wedge plate with respect to the outer ring.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a front view of a wedge clutch with wedge plate segments, a cage, and a resilient element, in a free-wheel mode;

FIG. 3 is a cross-sectional view generally along line 3-3 in FIG. 2 with an outer ring added;

FIG. 4 is a front view of a wedge plate segment in FIG. 2;

FIG. 5 is a cross-sectional view generally along line 5-5 in FIG. 4;

FIG. 6 is a front view of the wave spring in FIG. 2;

FIG. 7 is a back view of a cage prior to bending the retention tabs;

FIG. 8 is a cross-sectional view generally along line 8-8 in FIG. 7;

FIG. 9 is a cross-sectional view generally along line 9-9 in FIG. 2;

FIG. 10 is a front view of the wedge clutch in FIG. 2 in a locked mode; and,

FIG. 11 is a cross-sectional view generally along line 11-11 in FIG. 10 with the outer ring added.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

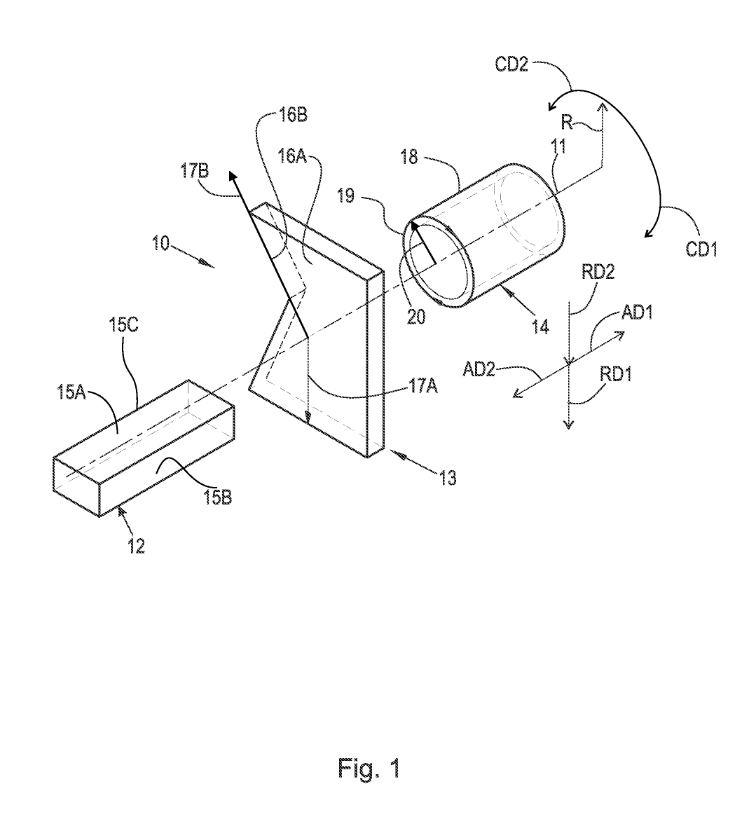

FIG. 1 is a perspective view of cylindrical coordinate system 10 demonstrating spatial terminology used in the present application. The present application is at least partially described within the context of a cylindrical coordinate system. System 10 includes axis of rotation, or longitudinal axis, 11, used as the reference for the directional and spatial terms that follow. Opposite axial directions AD1 and AD2 are parallel to axis 11. Radial direction RD1 is orthogonal to axis 11 and away from axis 11. Radial direction RD2 is orthogonal to axis 11 and toward axis 11. Opposite circumferential directions CD1 and CD2 are defined by an endpoint of a particular radius R (orthogonal to axis 11) rotated about axis 11, for example clockwise and counterclockwise, respectively.

To clarify the spatial terminology, objects 12, 13, and 14 are used. As an example, an axial surface, such as surface 15A of object 12, is formed by a plane co-planar with axis 11. However, any planar surface parallel to axis 11 is an axial surface. For example, surface 15B, parallel to axis 11 also is an axial surface. An axial edge is formed by an edge, such as edge 15C, parallel to axis 11. A radial surface, such as surface 16A of object 13, is formed by a plane orthogonal to axis 11 and co-planar with a radius, for example, radius 17A. A radial edge is co-linear with a radius of axis 11. For example, edge 16B is co-linear with radius 17B. Surface 18 of object 14 forms a circumferential, or cylindrical, surface. For example, circumference 19, defined by radius 20, passes through surface 18.

Axial movement is in direction axial direction AD1 or AD2. Radial movement is in radial direction RD1 or RD2. Circumferential, or rotational, movement is in circumferential direction CD1 or CD2. The adverbs “axially,” “radially,” and “circumferentially” refer to movement or orientation parallel to axis 11, orthogonal to axis 11, and about axis 11, respectively. For example, an axially disposed surface or edge extends in direction AD1, a radially disposed surface or edge extends in direction RD1, and a circumferentially disposed surface or edge extends in direction CD1.

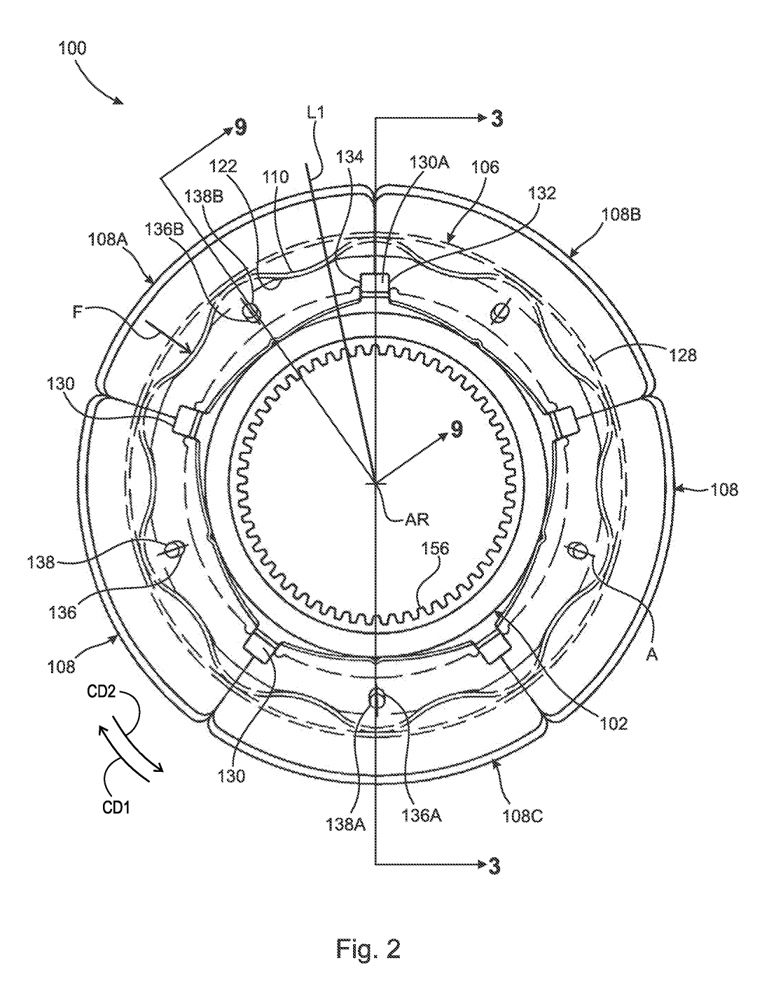

FIG. 2 is a front view of wedge clutch 100 with wedge plate segments, a cage, and a resilient element in a free-wheel mode.

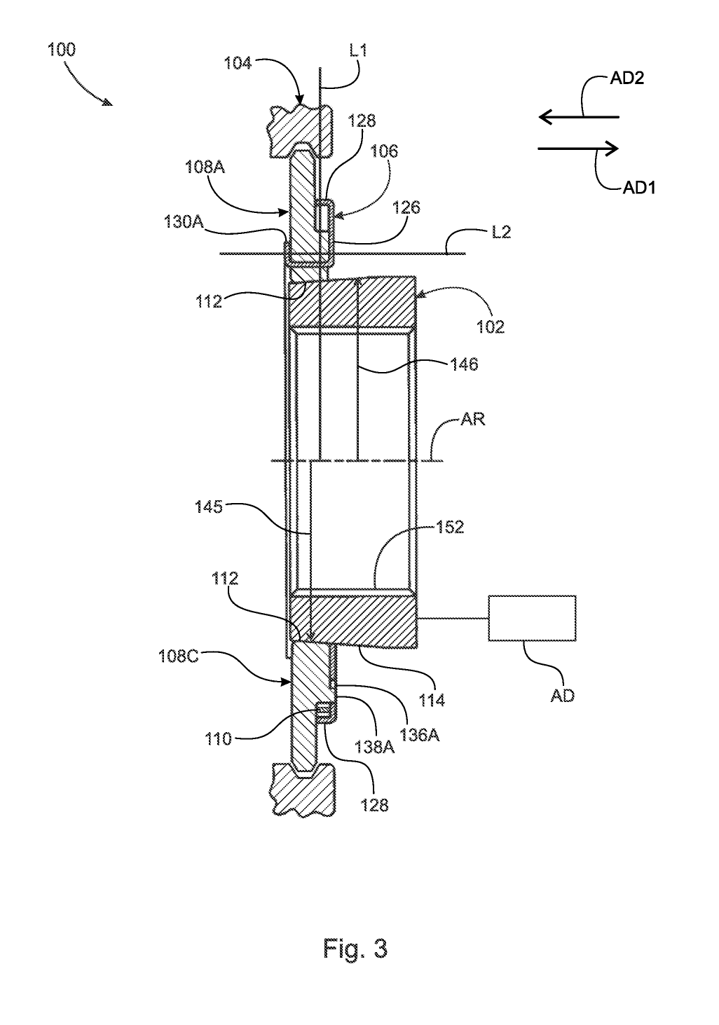

FIG. 3 is a cross-sectional view generally along line 3-3 in FIG. 2 with an outer ring added. The following should be viewed in light of FIGS. 2 and 3. Wedge clutch 100 includes: axis of rotation AR; hub 102; outer ring 104; cage 106; circumferentially aligned wedge plate segments 108; and circumferentially continuous resilient element 110. Ring 104 is located radially outward of hub 102. Cage 106 and segments 108 are radially disposed between hub 102 and outer ring 104. Resilient element 110 is engaged with cage 106 and segments 108, and urges segments 108 radially inward. In an example embodiment, element 110 is a wave spring.

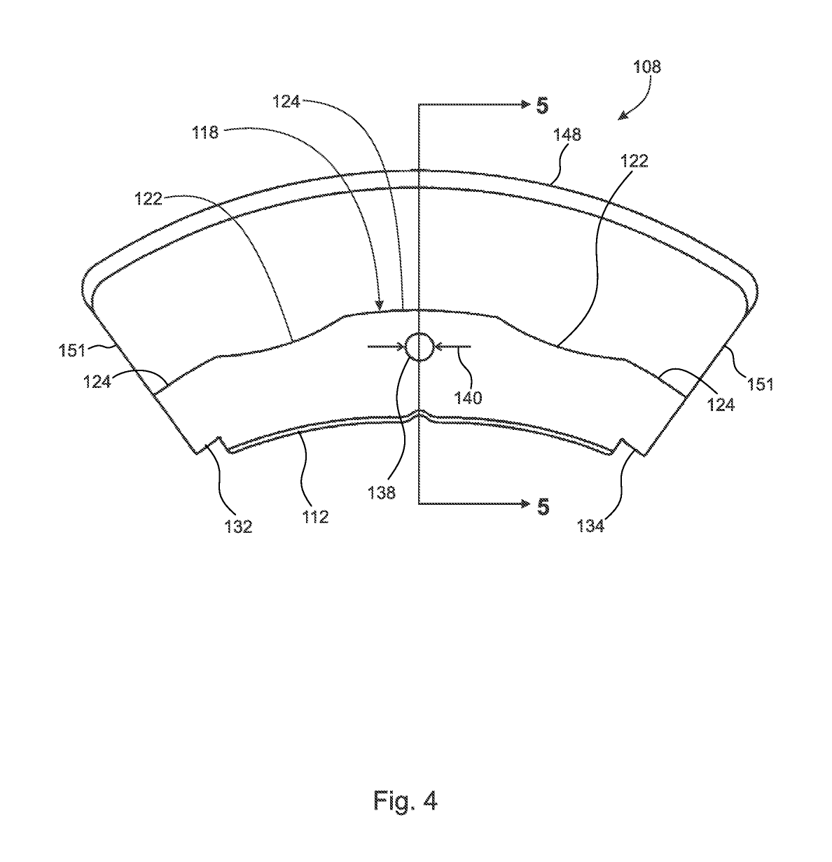

FIG. 4 is a front view of a wedge plate segment 108 in FIG. 2.

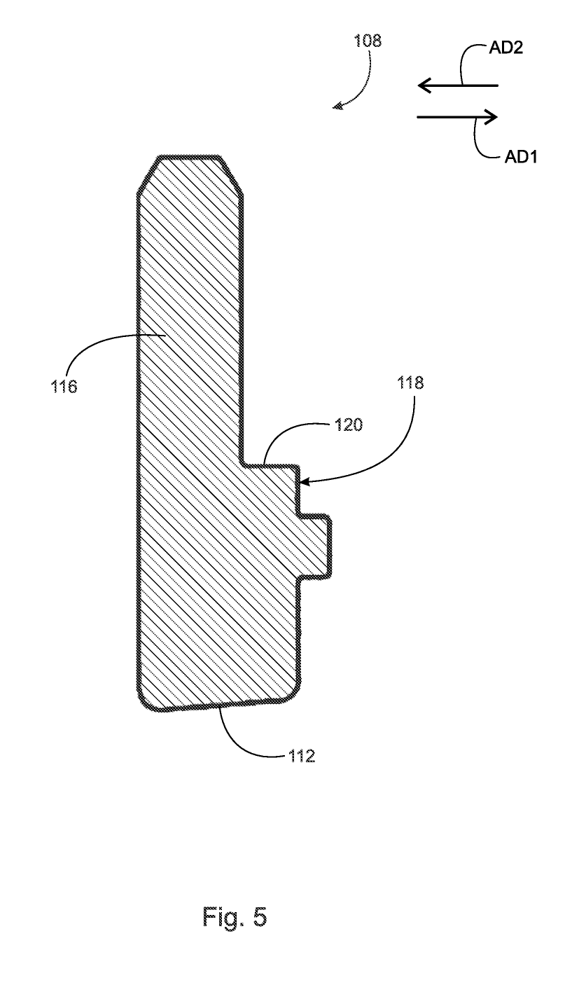

FIG. 5 is a cross-sectional view generally along line 5-5 in FIG. 4.

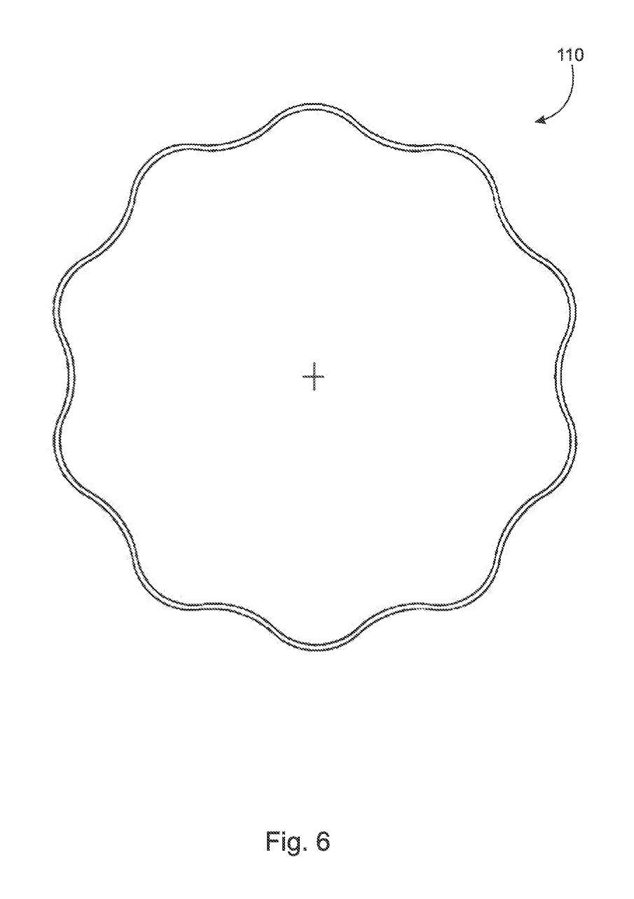

FIG. 6 is a front view of resilient element 110 in FIG. 2. The following should be viewed in light of FIGS. 2 through 6. By “circumferentially continuous,” we mean that resilient element 110 is a single piece without any breaks or splits, for example as seen in FIG. 6. Each segment 108 includes radially inner-most surface 112 in contact with radially-outermost surface 114 of hub 102. In an example embodiment, each wedge plate segment 108 includes radially extending body portion 116 and shoulder 118 extending from body portion 116 in axial direction AD1 or AD2. Resilient element 110 is engaged with shoulders 118. In an example embodiment, each shoulder 118 includes radially outermost surface 120 and surface 120 includes at least one recess 122 extending radially inward. For example, each segment 108 includes two recesses 122 and peak areas 124. Peak areas 124 are the radially outermost portions of surface 120. Resilient element 110 is engaged with recesses 122. By one component “engaged with” another component, we mean that the one component is in direct contact with the other component or the components are in contact with a mechanically solid intermediary or ancillary part. For example, a washer or coating could be disposed between the two components. In an example embodiment, resilient element 110 is in direct contact with shoulders 118 and recesses 122. Recesses 122 and peak areas 124 act to fix a circumferential position of element 110.

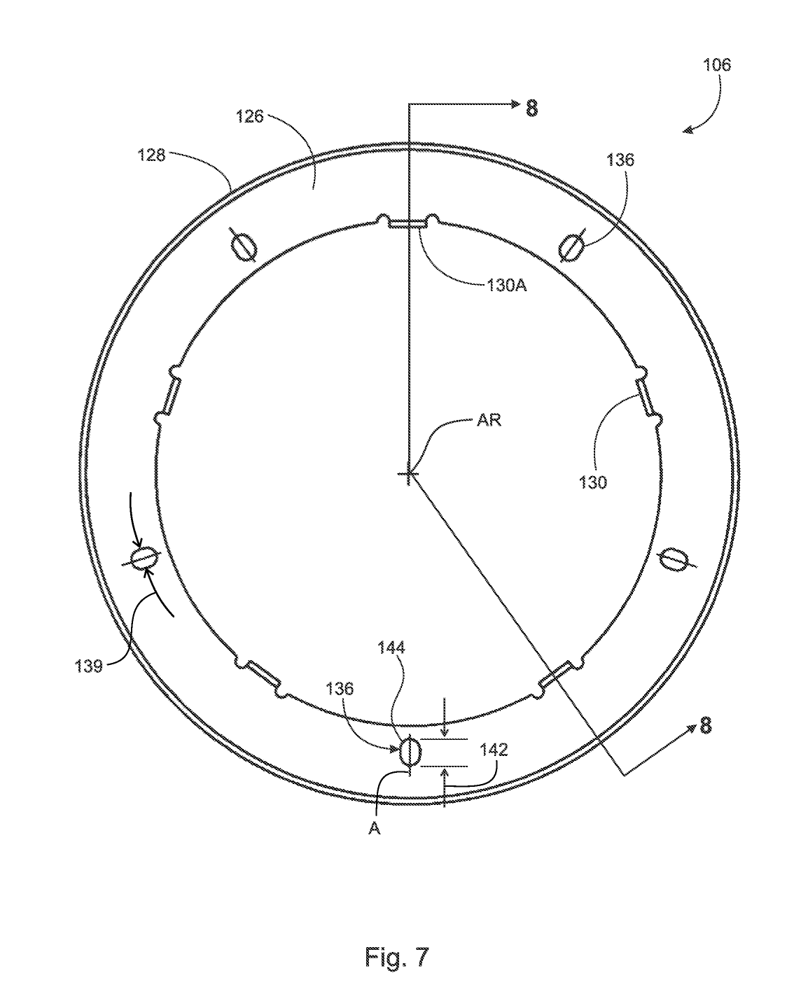

FIG. 7 is a back view of cage 106 prior to bending retention tabs.

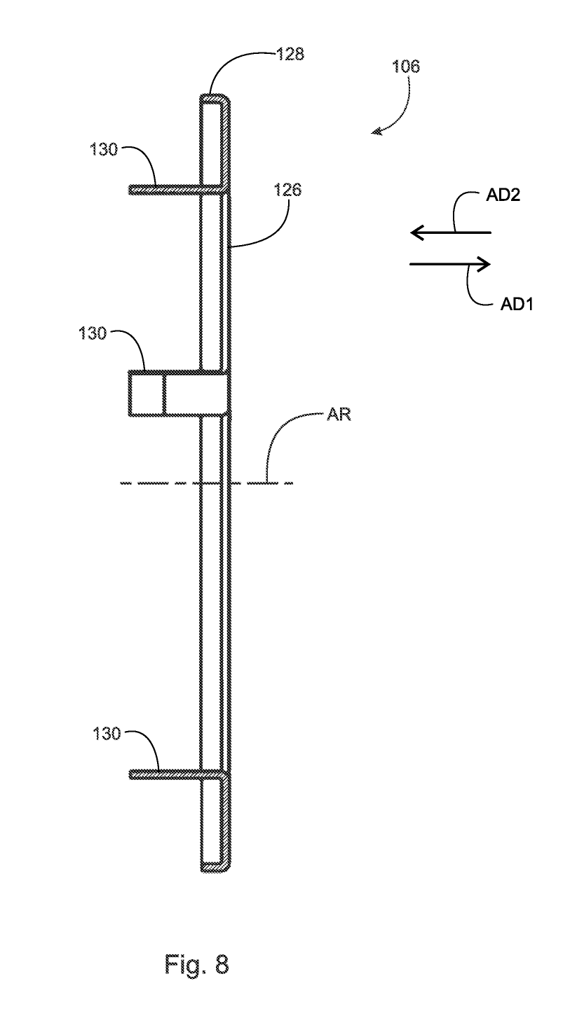

FIG. 8 is a cross-sectional view generally along line 8-8 in FIG. 7. The following should be viewed in light of FIGS. 2 through 8. In an example embodiment, cage 106 includes radially extending body portion 126 and flange 128 extending in axial direction AD2 from portion 126. Resilient element 110 is engaged with flange 128. Line L1, orthogonal to axis of rotation AR, passes through, in sequence, hub 102, a wedge plate segment 108 for example segment 108A, resilient element 110, and flange 128. In an example embodiment, line L1 passes through ring 104. In the discussion that follows, capital letters are used to designate a specific component from a group of components otherwise designated by a three digit number, for example, as implemented above, segment 108A is a specific example from the plurality of segments 108.

Cage 102 includes retention tabs 130 extending from body portion 126 in axial direction AD2. In FIGS. 7 and 8, cage 102 is shown before wedge clutch 102 is assembled. Assembly entails bending tabs 130 radially outward as shown in FIGS. 2 and 3. As shown in FIGS. 2 and 3, each tab 130 overlaps, in axial direction AD1 or AD2, two respective circumferentially adjacent wedge plate segments 108. For example, tab 130A overlaps segments 108A and 108B. Line L2, parallel to axis of rotation AR (that is, in direction AD1 or AD2) passes through, in sequence: body portion 126; a wedge plate segment, for example wedge plate segment 108A; and a retention tab, for example retention tab 130A.

In an example embodiment, each segment 108 includes at least one notch extending radially outward from radially innermost surface 112. In an example embodiment, each segment 108 includes notch 132 and notch 134. A respective retention tab 130 is disposed in respective notches 132 and 134 for circumferentially adjacent segments 108. For example, tab 130A is disposed in notch 134 for segment 108A and in notch 132 for segment 108B.

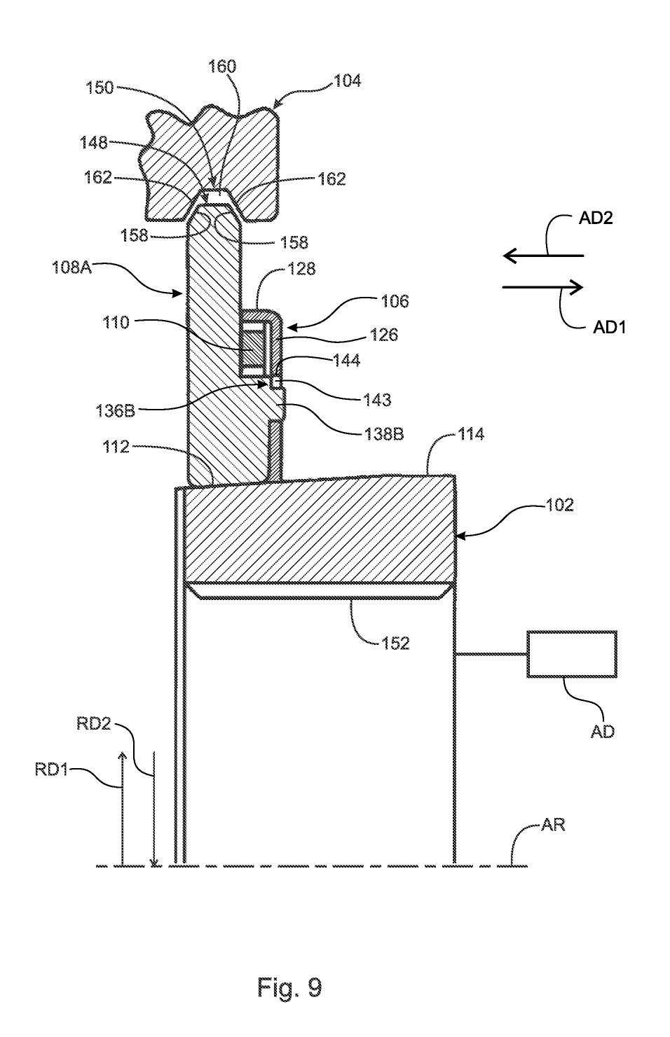

FIG. 9 is a cross-sectional view generally along line 9-9 in FIG. 2. The following should be viewed in light of FIGS. 2 through 9. In an example embodiment: cage 106 includes recesses 136 in body portion 126; and each wedge plate segment 108 includes protrusion 138 disposed in a respective recesses 136. In an example embodiment, recesses 136 are through-bores passing completely through material forming cage 106. For example, protrusion 138A for segment 108C passes through through-bore 136A. As further described below, segments 108 are radially displaceable such that protrusions 138 are radially displaceable within respective through-bores 136. For example, through-bores 136 extend further along axis A (orthogonal to axis AR) than in opposite circumferential directions CD1 or CD2. For example, circumferential dimension 139 of through-bores 136 is only slightly larger than outside diameter 140 of protrusions 138, such that there is nominal play in direction CD1 or CD2 between segments 108 and cage 106 when protrusions 138 are disposed in through-bores 136. However, length 142, in radial direction RD1, of through-bores 136 is sufficiently larger than diameter 140 to enable protrusions 138 to displace in through-bores 136 along axis A to enable the free-wheel and locked modes described below. For example as shown in FIG. 9, radial gap 143 is formed between protrusion 138B and edge 144 of through-bore 136B.

In the example of FIGS. 2, 3, and 9, surface 114 of hub 102 and surfaces 112 of segments 108 slope radially outward in direction AD1. That is, radius 145 of surfaces 112 and radius 146 of surface 114 increase moving in direction AD1.To transition from a locked mode (in which hub 102, ring 104 and segments 108 are non-rotatably connected), to the free-wheel mode shown in FIGS. 2, 3 and 9: hub 102 is axially displaced in axial direction AD1, for example by actuator device AD. Device AD can be any actuator known in the art, including, but not limited to a mechanical, hydraulic, electric actuator, pneumatic actuator, or electromagnetic actuator.

As hub 102 displaces in direction AD1, surfaces 112 slide down surface 114 and resilient element, reacting to radially fixed flange 128, displaces wedge plate segments 108 radially inward in radial direction RD2 to maintain contact between hub 102 (surface 114) and wedge plate segments 108 (surfaces 112). As segments 108 retract in direction RD2, outer surfaces 148 of segments 108 break contact with inner surface 150 of ring 104 and segments 108 (along with hub 102) are rotatable with respect to outer ring 104. By “non-rotatably connected” elements, we mean that: the elements are connected so that whenever one of the elements rotates, all the elements rotate; and relative rotation between the elements is not possible. Radial and/or axial movement of non-rotatably connected elements with respect to each other is possible, but not required.

As hub 102 displaces in axial direction AD1: resilient element 110 unwinds, expands, or decompresses, in radial direction RD2; and protrusions 138 slide through through-bores 136 in direction RD2. As noted above, width 139 of through-bores 138 is only slightly larger than diameter 140 of protrusions 138. As a result, there is nominal circumferential movement of segments 108 with respect to cage 106 as segments 108 displace radially inward. In an example embodiment, edges 151 of circumferentially adjacent segments—are in contact in the free-wheel mode.

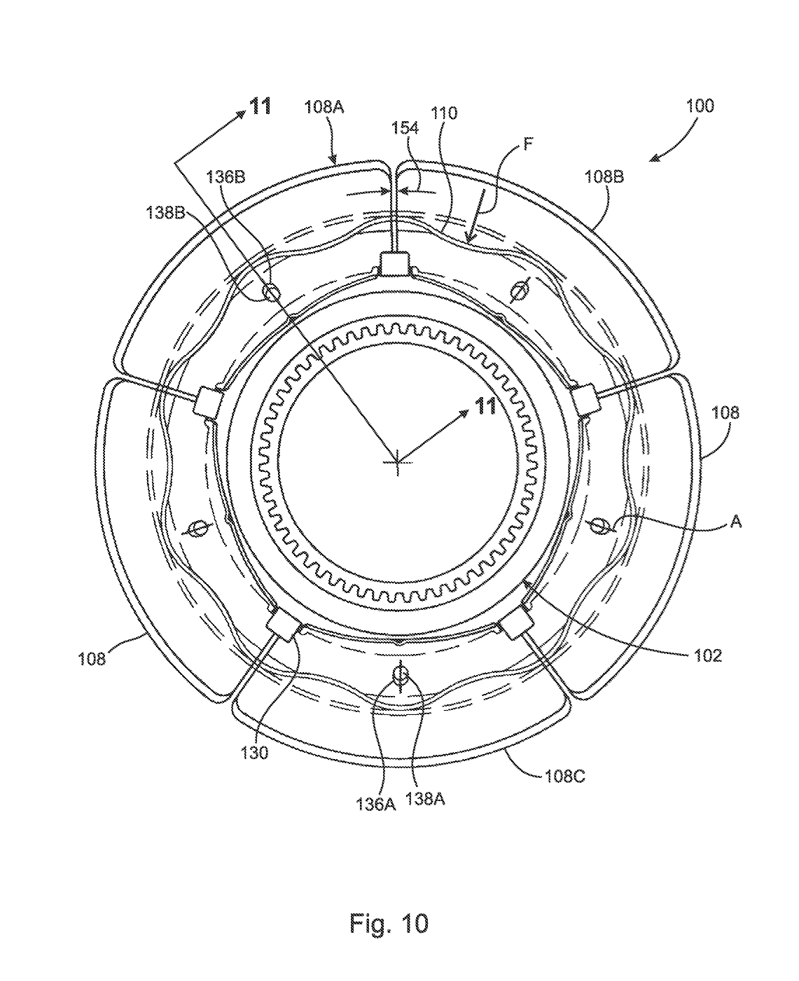

FIG. 10 is a front view of wedge clutch 100 in FIG. 2 in a locked mode.

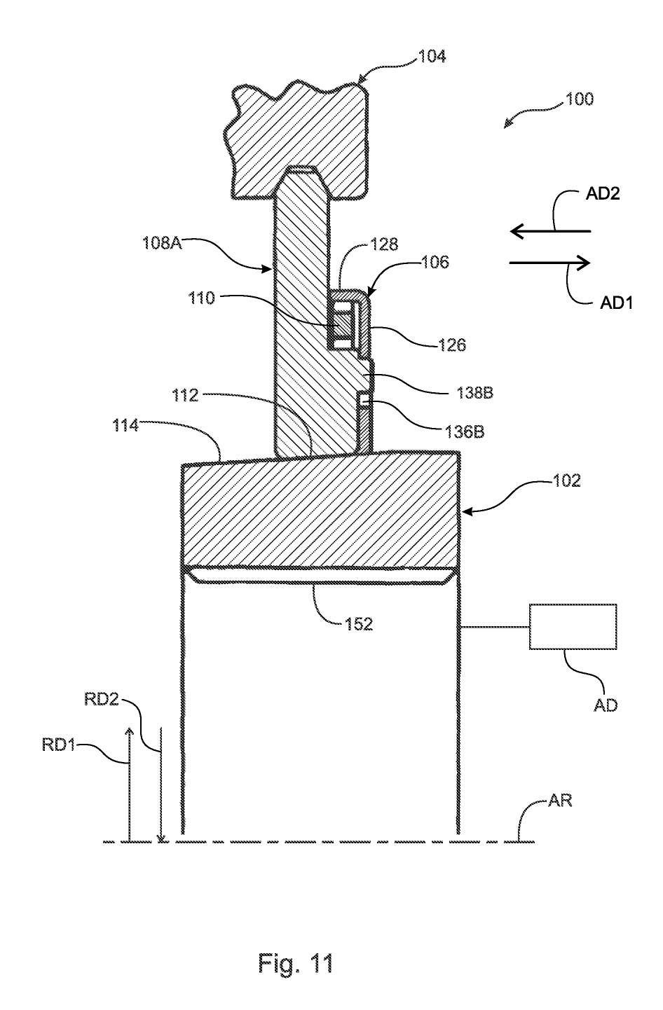

FIG. 11 is a cross-sectional view generally along line 11-11 in FIG. 10 with outer ring 104 added. The following should be viewed in light of FIGS. 2 through 11. To transition from the free-wheel mode to the locked mode, hub 102 is axially displaced, for example by device AD, in axial direction AD2, to displace segments 108 radially outward in radial direction RD1 into contact with outer ring 104. Thus, to implement the locked mode, surfaces 112 slide up surface 114, forcing segments 108, in particular surfaces 148 of segments 108, radially outward to contact ring 104, in particular surface 150. Hub 102 continues to displace in direction AD2 until circumferential torque, for example from the rotation of hub 102, causes wedge plate segments 108 to non-rotatably connect to hub 102 and outer ring 104, which non-rotatably connects hub 102 and ring 104. In the locked mode, torque from a driving shaft, for example non-rotatably connected to hub 102 is transmitted to a driven shaft, for example non-rotatably connected to ring 104.

As segments 108 are displaced radially outward in direction RD1: resilient element 110 is compressed in radial direction RD1 between shoulders 118 and cage 106, for example, between shoulders 118 and flange 128; and protrusions 138 slide through through-bores 136 in direction RD1. As in the example embodiment noted above, width 139 of through-bores 138 is only slightly larger than diameter 140 of protrusions 138, and there is nominal circumferential movement of segments 108, with respect to cage 106, as segments 108 displace radially outward. Therefore, a consistent circumferential orientation and spacing of segments 108 is maintained. For example, circumferential spacing 154 between segments 108 is evenly maintained between all the adjacent segments 108.

The following provides further detail regarding wedge clutch 100. In an example embodiment, hub 102 includes spline teeth 152 arranged to non-rotatably connect to a shaft (not shown). Ring 104 is arranged to non-rotatably connect to a second shaft. Thus, clutch 100 is usable to non-rotatably connect the shafts in the locked mode and enable relative rotation between the shafts in the free-wheel mode. In an example embodiment, surfaces 148 include chamfered surfaces 158 and surface 150 includes groove 160 with chamfered surfaces 162.

Although clutch 100 is shown with a particular number of wedge plate segments 108, it should be understood that clutch 100 is not limited to the number of segments 108 shown and that other numbers of segments 108 are possible. Although clutch 100 is shown with a particular axial orientation, it should be understood that other axial orientations are possible. For example, flange 128 could extend in direction AD1 and protrusions 138 could extend in direction AD2.

Advantageously, clutch 100 solves the problem noted above of unequal locking pressure in a locked mode and unequal radial movement of the wedge segments. In particular, resilient element 110 applies an equal force F to each segment 108, ensuring that segments 108 displace radially inward and radially outward in unison. For example, radius 145 changes uniformly for all of segments 108 during transitions between the locked and free-wheel mode, and radius 144 is uniform for each of segments 108 in the locked mode. Thus, equal locking pressure is applied by each of segments 108 during the locked mode. Further, resilient element 110 provides preloading force F to prevent segments 108 from displacing radially inward during the free-wheel mode, preventing an undesired shift from the free-wheel mode to the locked mode.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A wedge clutch, comprising:
an axis of rotation;
a hub;
an outer ring located radially outward of the hub;
a cage radially disposed between the hub and the outer ring;
a plurality of circumferentially aligned wedge plate segments radially disposed between the hub and the outer ring; and,
a circumferentially continuous resilient element engaged with the cage and the plurality of circumferentially aligned wedge plate segments, and urging the plurality of circumferentially aligned wedge plate segments radially inward.

2. The wedge clutch of claim 1, wherein each wedge plate segment in the plurality of circumferentially aligned wedge plate segments includes a radially inner-most surface in contact with the hub.

3. The wedge clutch of claim 1, wherein:
the cage includes a flange extending in an axial direction; and,
the circumferentially continuous resilient element is engaged with the flange.

4. The wedge clutch of claim 3, wherein a line, orthogonal to the axis of rotation, passes through, in sequence, the hub, a wedge plate segment included in the plurality of circumferentially aligned wedge plate segments, the circumferentially continuous resilient element, and the flange.

5. The wedge clutch of claim 1, wherein:
the cage includes:
a radially extending body portion; and,
a plurality of retention tabs extending from the radially extending body portion in a first axial direction; and,
each tab in the plurality of retention tabs overlaps, in the first axial direction, respective first and second circumferentially adjacent wedge plate segments included in the plurality of circumferentially aligned wedge plate segments.

6. The wedge clutch of claim 5, wherein a line parallel to the axis of rotation passes through, in sequence:
the radially extending body portion;
a wedge plate segment included in the plurality of circumferentially aligned wedge plate segments; and,
a retention tab included in the plurality of retention tabs.

7. The wedge clutch of claim 5, wherein:
the first wedge plate segment includes a notch extending radially outward from a radially innermost surface of the first wedge plate segment;
the second wedge plate segment includes a notch extending radially outward from a radially innermost surface of the second wedge plate segment; and,
a retention tab, included in the plurality of retention tabs, is disposed in the respective notches for the first and second wedge plate segments.

8. The wedge clutch of claim 1, wherein:
the cage includes:
a radially extending body portion; and,
a plurality of recesses or through-bores in the radially extending body portion; and,
each wedge plate segment included in the plurality of circumferentially aligned wedge plate segments includes a protrusion disposed in a respective recess or through-bore included in the plurality of recesses or through-bores.

9. The wedge clutch of claim 8, wherein the plurality of circumferentially aligned wedge plate segments are radially displaceable such that the protrusion for said each wedge plate, disposed in the respective recess or through-bore, is radially displaceable within the respective recess or through-bore.

10. The wedge clutch of claim 1, wherein:
each wedge plate segment, included in the plurality of circumferentially aligned wedge plate segments, includes:
a radially extending body portion; and,
a shoulder extending from the body portion in an axial direction; and,
the circumferentially continuous resilient element is engaged with the shoulder for said each wedge plate segment.

11. The wedge clutch of claim 10, wherein:
the shoulder for said each wedge plate segment includes a radially outermost surface;
the radially outermost surface includes at least one recess extending radially inward; and,
the circumferentially continuous resilient element is engaged with the at least one recess for the shoulder for said each wedge plate segment.

12. The wedge clutch of claim 1, wherein:
the hub includes a radially outermost surface sloping radially outward in a first axial direction;
for a locked mode:
the hub is axially displaceable in a second axial direction, opposite the first axial direction, to displace the plurality of circumferentially aligned wedge plate segments radially outward into contact with the outer ring; and,
the plurality of circumferentially aligned wedge plate segments are arranged to non-rotatably connect to the hub and the outer ring; and,
for a free-wheel mode:
the hub is axially displaceable in the first axial direction;
the circumferentially continuous resilient element is arranged to displace the plurality of circumferentially aligned wedge plate segments radially inward to maintain contact between the hub and the plurality of circumferentially aligned wedge plate segments between; and,
the plurality of circumferentially aligned wedge plate segments is rotatable with respect to the outer ring.

13. The wedge clutch of claim 12, further comprising:
a displacement device, wherein:
for the locked mode, the displacement device is arranged to displace the hub in the second axial direction; and,
for the free-wheel mode, the displacement device is arranged to displace the hub in the first axial direction.

14. A wedge clutch, comprising:
an axis of rotation;
a hub including a radially outermost surface sloping radially outward in a first axial direction;
an outer ring located radially outward of the hub;
a plurality of circumferentially aligned wedge plate segments:
radially disposed between the hub and the outer ring; and,
in contact with the hub;
a cage radially disposed between the hub and the outer ring and including a plurality of retention tabs, each retention tab, included in the plurality of retention tabs, overlapping a respective pair of circumferentially aligned wedge plate segments included in the plurality of circumferentially aligned wedge plate segments; and,
a resilient element engaged with the cage and the plurality of circumferentially aligned wedge plate segments, and urging the plurality of circumferentially aligned wedge plate segments radially inward, wherein:
for a locked mode:
the hub is axially displaceable in a second axial direction, opposite the first axial direction, to displace the plurality of circumferentially aligned wedge plate segments radially outward into contact with the outer ring; and,
the plurality of circumferentially aligned wedge plate segments is arranged to non-rotatably connect to the hub and the outer ring; and,
for a free-wheel mode:
the hub is axially displaceable in the first axial direction;
the resilient element is arranged to displace the plurality of circumferentially aligned wedge plate segments radially inward; and,
the plurality of circumferentially aligned wedge plate segments is rotatable with respect to the outer ring.

15. The wedge clutch of claim 14, wherein:
the cage includes:
a radially extending body portion; and,
a flange extending from the radially extending body in a second axial direction, opposite the first axial direction;
each wedge plate segment, included in the plurality of circumferentially aligned wedge plate segments, includes:
a radially extending body portion; and,
a shoulder extending from the body portion in the first axial direction; and,
the resilient element is engaged with the flange and with the shoulder for said each wedge plate segment.

16. The wedge clutch of claim 14, wherein:
the cage includes:
a radially extending body portion; and,
a plurality of through-bores passing through the radially extending body portion;
each wedge plate segment, included in the plurality of circumferentially aligned wedge plate segments, includes a protrusion disposed in a respective through-bore included in the plurality of through-bores; and,
a length of the respective through-bore, in a radial direction, is greater than a circumferential dimension of the respective through-bore.

17. A method of operating a wedge clutch including a hub, an outer ring, a resilient element, a plurality of wedge plate segments radially located between the hub and the outer ring, and a cage radially located between the hub and the outer ring, the method comprising:
engaging, with the resilient element, the cage and the plurality of circumferentially aligned wedge plate segments;
urging, with the resilient element, the plurality of circumferentially aligned wedge plate segments radially inward;
contacting the hub with the plurality of circumferentially aligned wedge plate segments;
for a locked mode:
displacing the hub in a first axial direction;
displacing, with the hub, the plurality of circumferentially aligned wedge plate segments radially outward into contact with the outer ring; and,
non-rotatably connecting the plurality of circumferentially aligned wedge plate segments with the hub and the outer ring; and,
for a free-wheel mode:
displacing the hub in a second axial direction opposite the first axial direction;
displacing, with the resilient element, the plurality of circumferentially aligned wedge plate segments radially inward; and,
rotating the plurality of circumferentially aligned wedge plate with respect to the outer ring.

18. The method of claim 17, further comprising:
blocking, with a body of the cage and a plurality of retention tabs extending from the body of the cage, movement of the plurality of circumferentially aligned wedge plate segments in the first and second axial directions, wherein displacing, with the hub, the plurality of circumferentially aligned wedge plate segments radially outward and radially inward includes displacing, radially outward and radially inward respectively, a protrusion, axially extending from said each wedge plate segment, through a respective through-bore in the body of the cage.

19. The method of claim 17, further comprising:
engaging a respective portion of the resilient element with at least one radially inwardly extending indentation in a radially outermost surface of each wedge plate segment included in the plurality of circumferentially aligned wedge plate segments; and,
fixing a circumferential position of the resilient element with respect to the plurality of circumferentially aligned wedge plate segments.

20. The method of claim 17, wherein:
displacing, with the hub, the plurality of circumferentially aligned wedge plate segments radially outward into contact with the outer ring includes radially compressing the resilient element; and,
displacing, with the resilient element, the plurality of circumferentially aligned wedge plate segments radially inward includes radially expanding the resilient element.
